(19) United States
(12) Patent Application Publication
(10) Pub. No.: US 2023/0098429 A1
(43) Pub. Date: Mar. 30, 2023

(54) System for repurposing cardboard into a cat scratching surface

(71) Applicant: Charles Eduardo Snyder, Alexandria, VA (US)

(72) Inventor: Charles Eduardo Snyder, Alexandria, VA (US)

(21) Appl. No.: 17/485,368

(22) Filed: Sep. 25, 2021

(51) Int. Cl. A01K 15/02; B31D 3/00

(52) U.S. Cl. CPC A01K 15/024; B31D 3/007

(57) ABSTRACT

This invention relates to the improvements in cat clawing/scratching pads and the like—providing the user with a means to convert cardboard into renewed cat scratching surfaces. This cat scratching system enables the guided cutting of user-supplied cardboard into strips and subsequent filing of those strips into a shell in such a way that exposed strips serve as a cat scratching surface. After wear or destruction of filed cardboard strips through cat scratching, clawing, pulling, tearing, or general degradation (e.g., accumulation of cat hair) cardboard can be removed from the cat scratching system. The process of cutting cardboard strips and storing is repeated to enable renewal of the cat scratching surfaces from the user's cardboard source of choice (e.g., repurpose corrugated cardboard commonly found in delivered packages).

### BACKGROUND OF TEE INVENTION

### (1) Field of the Invention

This invention relates generally to the field of cat scratching posts, pads, or other geometries that relate to cat scratching/clawing products.

### (2) Description of Related Art

Domestic cat nail health is important for cats for running, walking, jumping, climbing, territory marking, hunting, and defending. As part of claw maintenance, domestic cats scratch surfaces to dull claws and slough off the dull layer of the feline forepaws—exposing sharp nails. Cats often use rough surfaces—from bark and cinderblock to carpet and sofas—for this claw maintenance activity.

The act of scratching typically degrades/damages the surface scratched upon. Indoor cats, lacking natural rough surfaces (e.g., tree trunks) often turn to carpet, upholstered or rattan furniture, bedding, curtains, walls, doors, or other household items that provide suitable friction from a cat scratch.

To prevent the damage of household items from cat scratching, a cat owner can declaw the animal, attach nail caps to the cat nails, apply tacky materials to surfaces (that are unappealing to a cat), apply chemical deterrents, employ a variety of deterrent motion sensor devises (e.g., proximity aerosol spray devices), attempt training, or provide a suitable scratching surface that is more appealing than household items in the form of scratching posts, scratching pads, or other cat scratching surfaces (hereafter, cat scratcher).

To entice the pet cat from scratching household furniture, a number of manufacturers have created dedicated sacrificial scratching surface products. Such products include posts or pads in a variety of shapes and orientations. These products provide a surface composed of a rough material that is appealing to cats such as cork, carpet, cardboard, rope, sisal, seagrass, and other abrasive materials. Overtime, the scratching surface is degraded from cat scratching, but this degradation is typically preferred over the destruction of non-cat-related household items.

Many cat scratchers use cardboard as the cat-enticing abrasive surface. Typically cardboard is sliced to expose the corrugated, honeycomb-like structure as in U.S. Pat. No. 3,486,485A, USD387512S, USD900414S1, US776595662, US20180352785A1, US20170265433A1, US20140014043A1, and US20040139926A1. This prior art demonstrates the use of cardboard as a scratching surface. Once the sacrificial cardboard surface is degraded from scratching, the utility of the prior art as a cat scratching surface also degrades. If the prior art allows, the cardboard surface might be replaced by pre-assembled cardboard inserts. If such replacement of the cardboard is not a feature, the prior art must be completely replaced to restore full functionality.

This invention enables the user to restore scratcher functionality from their cardboard source of choice, to include repurposing of corrugated cardboard boxes commonly used for package delivery.

### BRIEF SUMMARY OF THE INVENTION

With the scratching surface of cardboard-based cat scratcher prior art known to degrade with use, it is the object of the present invention to provide a device that enables users to initialize and replace cardboard scratching surfaces with cardboard. A benefit of this invention is to enable the repurposing of waste boxes (e.g., boxes obtained from delivered packages).

The present invention is comprised of a shell, a fence and a cutting guide. The cutting guide is connected to the shell by a fence. The shell's cutting surface, fence, and cutting guide form a slot such that when the user inserts cardboard into the slot—abutted to the fence and between the cutting guide and shell surface, the user can apply common cutting tools (e.g., box cutter) through the cardboard into the shell surface, while drawing the cutting tool along the edge of the cutting guide farthest away from the fence. The combination of shell surface, cutting guide, and fence enables the user to cut cardboard into strips of precise width. After cutting the cardboard into strips, the user can then file the strips into the shell.

The shell consists of a base, sidewalls, aforementioned cutting surface, and cross arms. With the interior height of the shell matching the width the cut cardboard strips, the user files cut strips into the interior of the shell. Because of the slight compressibility of cardboard, the shell, fully-loaded with cardboard strips, provides adequate friction to hold the strips in place. The shell exposes the side of the filed strips as a cat scratching surface.

As the exposed rough surface of the filed cardboard strips deteriorates from scratching, the strips can be flipped 180 degrees—exposing a fresh side of the cardboard. As cardboard completely deteriorates, the user can replace in whole or in part the damaged strips by cutting new strips using the cutting guide.

### BRIEF DESCRIPTION OF THE SEVERAL VIEWS OF THE DRAWINGS

FIG. 1 shows the complete cat scratcher system with user-cut cardboard strips filed into the shell.

FIG. 2 shows the complete cat scratcher system without cardboard inserts; it also shows where a user might apply a cutting tool to the cutting surface of the shell if arbitrary (unguided) cuts are needed.

FIG. 3 shows the complete cat scratcher system without cardboard inserts; it also shows where a user might apply a cutting tool to the shell's cutting surface to make guided cuts.

FIG. 4 shows the complete cat scratcher system with the cutting guide articulated out of plane with the cutting surface of shell to enable ease of access to shell surfaces should the user elect to use the shell surface as a cutting board without the cutting guide.

FIG. 5 shows cardboard inserted into the cat scratcher system, held by the cutting guide, and sliced by a cutting device to create strips of required width; a cutting device (e.g., box cutter) is applied perpendicular to the cutting surface of the shell, flush with the edge of the cutting guide farthest away from the fence; the cardboard is abutted against the fence and positioned between the cutting guide, the shell's cutting surface.

FIG. 6 shows an example of how the surface of the shell might be used to make arbitrary cardboard cuts.

FIG. 7 shows an example of how the surface of the shell might be used to make arbitrary cardboard cuts from a different perspective than FIG. 6. FIG. 7 also shows how the arbitrary cutting surface might be used to trim cardboard that might have a greater length than the longest dimension of the cat scratcher system.

FIG. 8 shows how a user can insert cut cardboard strips into the cat scratcher system to file the strips into a scratching surface.

FIG. 9 shows how a cat might use the filed, cut cardboard as a scratching surface.

### DETAILED DESCRIPTION OF THE INVENTION

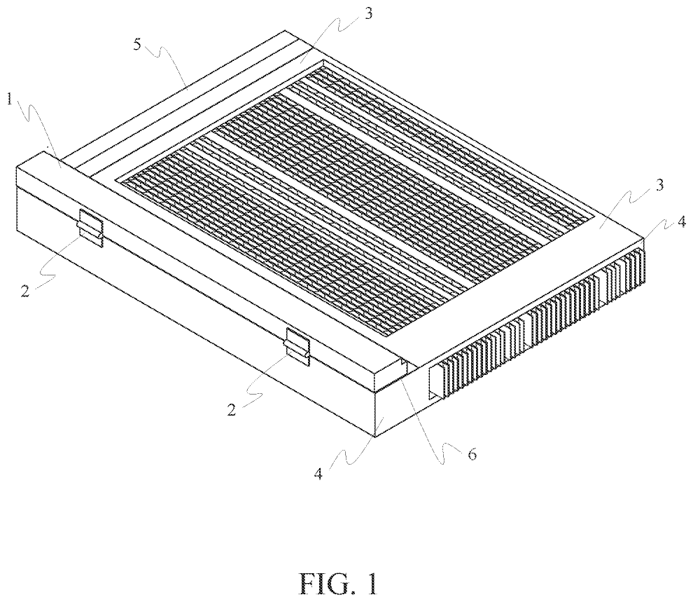

FIGS. 1 through and 9 show the cat scratching system of the present invention from various perspectives. FIG. 1 shows the cat scratching system in its complete end state: filled with user-cut cardboard. This view shows the cutting guide 1 attached through the fence 2 to the shell (i.e., the box holding the cardboard strips), where the shell is comprised of the cross arms 3, the shell sides 4, the cutting surfaces 5 and 6, and the shell base 7. The following paragraphs describe the additional annotated components—3, 4, 5, 6, and 7.

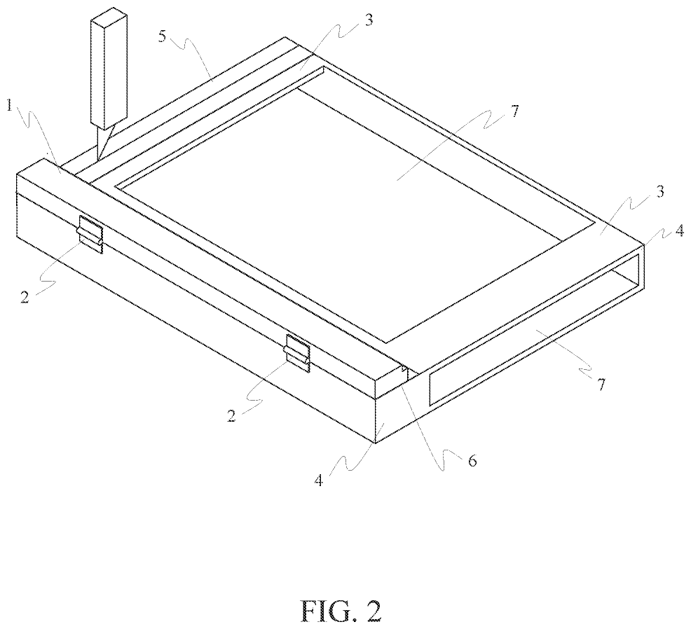

FIG. 2 shows the cat scratching system prior to the filing of user-cut cardboard. From this view, all portions of the shell are visible: cross arms 3, shell sides 4, cutting surfaces 5 and 6, and shell base 7. Note that the shell's top surface is the cutting surface (i.e., the top of the box), and this surface is comprised of, in part, the cross arms 3. The cutting surface of is differentiated as 5 and 6 to differentiate the surface of the cross arms (used as an unguided cutting surface) and the guided cutting surface respectively.

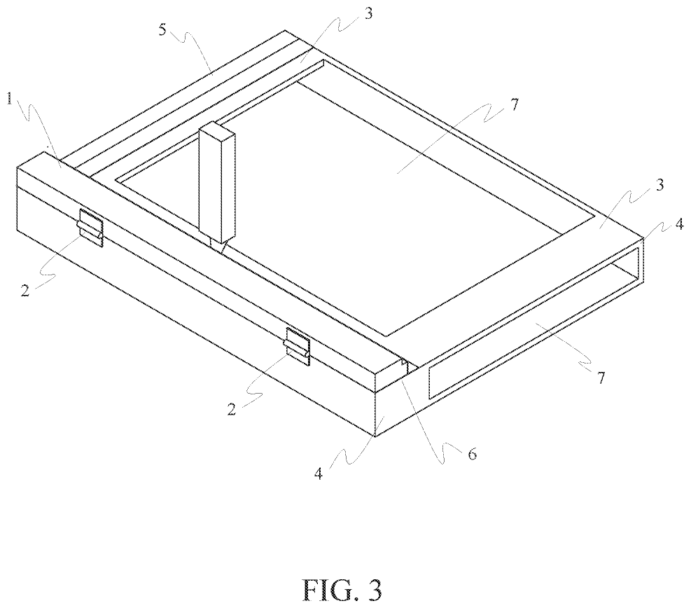

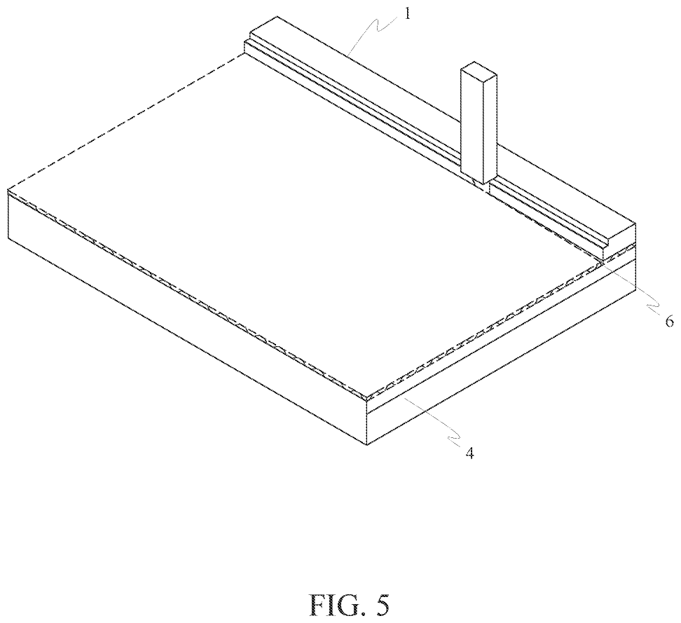

To prepare cardboard strips, users implement one of the main features that differentiates this invention from prior art: the cutting guide 1. The cutting guide 1 is attached to the shell of the cats scratching system via the fence 2. FIG. 3 and FIG. 5 show how a cutting tool (e.g., box cutter) aligns with the cutting guide 1. FIG. 5 shows user-inserted cardboard between the cutting guide 1 and the shell's cutting surface: cardboard is fitted/abutted against the fence 2 in this way by the user. The user exerts pressure on the cardboard and cutting guide 1 in such a way as to pinch and hold the cardboard between the cutting guide 1 and the shell base.

FIG. 5 also show the cardboard held in place with a cutting tool in planar alignment with the cutting guide 1 and perpendicular to the base shell. In this way, the cutting guide serves to guide the cutting tool such that the resulting strips are of thickness equal to the distance between the fence 2 and edge of the cutting guide opposite the hinge/fence 2. A hardened surface, 6, protects the invention from the cutting tool as the user applied pressure while slicing the cardboard. The resulting strip width is equal to the interior distance between the shell base 7 and the shell's cross arms 3 (depicted in FIG. 2).

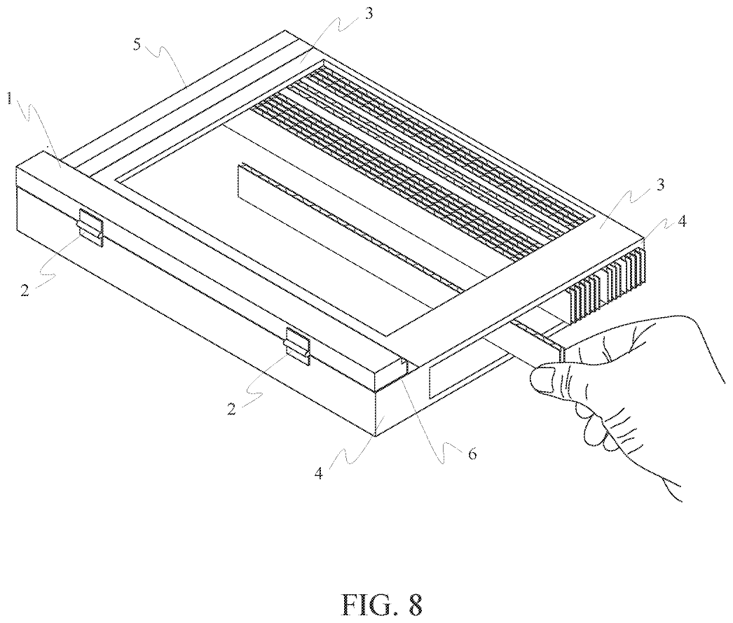

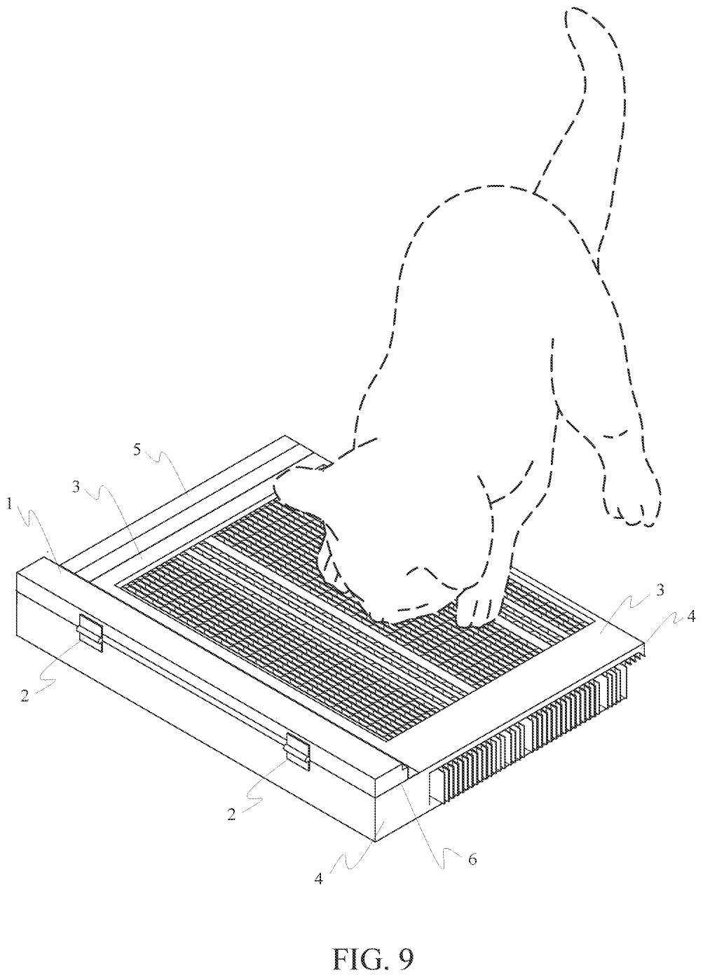

FIG. 8 shows how the user inserts the user-cut cardboard strips through the opening of the shell created by the shell base 7, shell sides 4, and cross arms 3. By filing the cut strips into the shell (as shown in FIG. 1, FIG. 8, and FIG. 9) the cut strips stay in place through friction between the cross arms 3 and the shell base 7. Additionally, the compressibility of the strips enables the user to wedge strips into the shell such that pressure applied by the shell sides 4 adds additional friction to the system, keeping the filled strips in place.

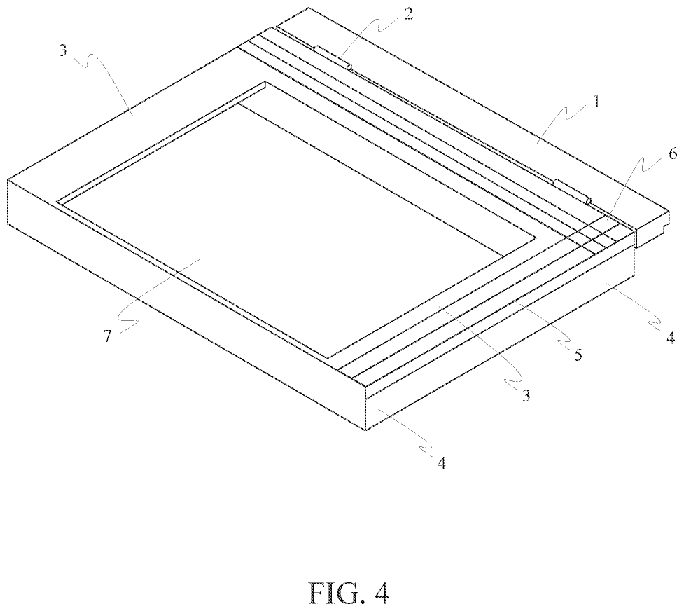

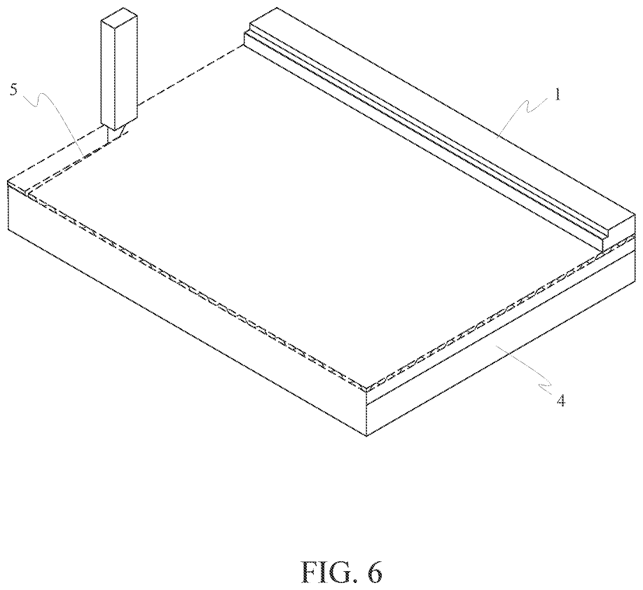

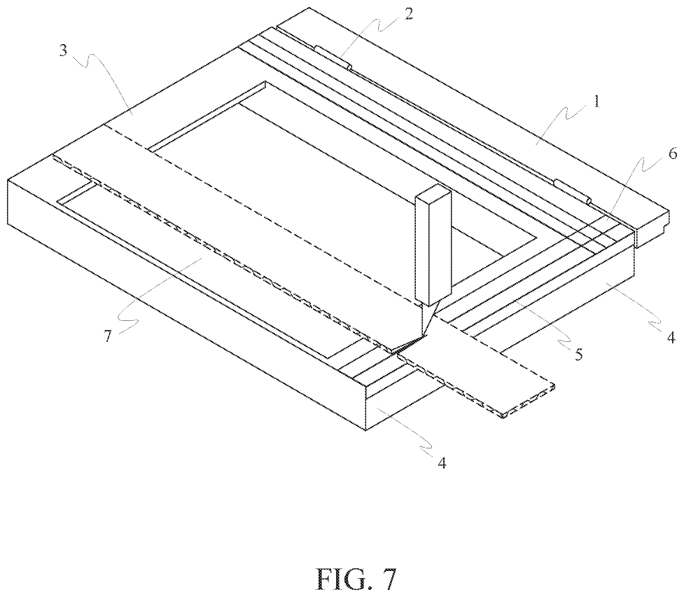

The shell's cutting surface 5 (as seen in FIG. 6, and FIG. 7), serves as an unguided cutting surface. FIG. 6 and FIG. 7 show cutting cardboard in an arbitrary manner with a user-operated cutting tool piercing the cardboard without the use of the cutting guide 1. When cutting this way, the cutting guide 1 can be articulated out of plane as shown in FIG. 4 and FIG. 7. Note that this surface includes the surface of the cross arms 3 which are part of the shell. Access to such surfaces can be useful in preparing the strips, since the cutting guide 1 helps the user obtain the correct width of cardboard strips for filing into the shell, but the user might want to adjust the length.

The hardened cutting surfaces 5 and 6 can have an additional groove to bring the edge/tip of the cutting tool below the surface of the hardened cutting surface. In this way, the groove provides additional cutting guidance while allowing the blade to fully penetrate through the cardboard. However, this groove is depicted in the unguided cutting surface 5 and guided cutting surface 6. This is not necessary for full function as cardboard can be cut with a cutting tool piercing/slicing through the cardboard with pressure applied to a completely flat surface. Alternatively, for guided cuts, a grooved or channeled cutting surface can suffice as a guide unto itself, eliminating the need for 1 to be in contact with the blade. For example, a groove can consist of a u-channel, two l-channels, two side-by-side rods, or simply a flat surface with a pressed indent.

With the exception of cutting surfaces 5 and 6, the cat scratching system can be made from a variety of suitably-sturdy materials to include wood or plastic. Cutting surfaces must be suited to resist degradation from cutting tool pressure. Suitable materials include certain metals (e.g., steel), ceramic, and some self-healing polymers.

A non-slip surface (e.g., coating, rubberized/plasticized feet) can be applied to the bottom of the base of the shell (the unseen portion of 7) to help the user keep the cat scratching system in place while cutting. Holes and other attachments may be added to the bottom of the base of the shell (the unseen portion of 7) to enable wall hanging.

The relative dimensions of the cat scratcher system provided herein and provided size reference in FIG. 9 were selected to enable use of commonly used shipping boxes, but the invention is not constrained to these dimensions. The invention might be sold in a variety of sizes and shapes. Other heights, widths, and depths, or geometries of the invention fall within the spirit of the invention. The flexible nature of cardboard strips enables filing in ways only limited to the 2D projected geometry of the shell. For example, after cutting strips, the strips filed into a rectangular-shaped shell create a rectangular scratching surface plane, but might just as easily be filed into a shell imparting a wavy or even circular scratching plane.

The fence 2 need not be a hinge mechanism. A simple, semi-ridged connection also served as a fence while allowing enough flexibility for the user to apply pressure to hold cardboard in place while cutting. Likewise, attaching the cutting guide 1 through simple, loose pegs can achieve the same functionality of fence guidance and cardboard fixation. The spirit of the functionality is to provide a fence/stop to right-size the width of cut cardboard strips, provide the user some protection when cutting, and hold the cardboard in place while cutting.

FIG. 9 shows the invention being used by a cat.

The embodiments of the invention described herein are exemplary and numerous modifications, variations and rearrangements can be readily envisioned to achieve substantially equivalent results, all of which are intended to be embraced within the spirit and scope of the invention: a cat scratching system that enables the user to repurpose cardboard into a useable cat scratcher.

1. A cat scratching system comprising
a shell comprising a cutting surface, cross arms, base, and side walls;
a cutting guide; and
a fence connecting the shell and the cutting guide
wherein the shell's cutting surface, the cutting guide and the fence form a slot to accept cardboard: enabling the guided cutting of cardboard strips and storage of said strips in the shell such that said strips serve as a suitable cat scratching surface.

2. The cat scratching system of claim wherein the cutting guide further comprises an edge

3. The cat scratching system of claim 1 wherein the distance between the fence and the cutting guide's edge farthest from the fence is equal to the inner distance between the shell's base and the shell's cross arms.

4. The cat scratching system of claim 1 wherein the shell's cutting surface of claim 1, the cutting guide, and the fence of claim 1 form a slot template such that when cardboard is inserted in to slot, abutted against the fence, application of common cutting tools (e.g., a box cutter) perpendicular to the cutting surface of claim 1 and in contact with the cutting guide of claim 1 results in a cardboard strip of width equal to the inner distance between the base and cross arms of the shell of claim 1. A cutting guide of claim 3 that accommodates a variety of cutting tools used to cut cardboard—tools organic to claim 1 or otherwise.
